(19) United States
(12) Patent Application Publication
(10) Pub. No.: US 2021/0317908 A1
(43) Pub. Date: Oct. 14, 2021

(54) HYDRAULIC DRIVE ACCELERATOR

(71) Applicant: Randy Payne, Chaffee, MO (US)

(72) Inventor: Randy Payne, Chaffee, MO (US)

(21) Appl. No.: 16/843,006

(22) Filed: Apr. 8, 2020

(51) Int. Cl. F16H 57/08; F15B 21/14

(52) U.S. Cl. CPC F16H 57/082; F15B 3/00; F15B 21/14

(57) ABSTRACT

A hydraulic accelerator for providing an improved hydraulic accelerator within a hydraulic drive system is disclosed. The hydraulic accelerator is constructed from a set of four (4) top blades, a set of four (4) bottom blades, a bottom rod, a hen gear, a planetary gear small, a top rod, a planetary gear assembly, a middle bearing seat tube, and a funnel. Each of the top blades are combined with a corresponding bottom blade and the pair of blades are located at 90° angles from each other around a central axis. The central axis consists of the top rod and the bottom rod that are attached to each end of the middle bearing seat tube.

### TECHNICAL FIELD

This application relates in general to an article of manufacture for providing an improved hydraulic accelerator within a hydraulic drive system.

### BACKGROUND

It is well-known to transfer energy from a source such as a motor or internal combustion engine to a load through the intermediary of hydraulic drive system. Such systems will typically have a pump driven by the source and a motor connected to the load. By adjusting the hydraulic flow between the pump and the motor it is possible to impart movement to the load, maintain it in a fixed position and otherwise influence its disposition.

Such hydraulic drive systems usually include a primary drive unit, e.g. an internal combustion engine or an electric motor which drives one or more hydraulic pumps, in order to provide hydraulic energy for driving the apparatus. To increase the performance of such systems, it is first of all possible to dimension the drive unit larger, so as to be able to also provide more hydraulic energy. With increasing size of the primary drive unit, however, the costs, the packaging space and the energy consumption of the system are also increasing.

For this reason, hydraulic energy accumulators are used to an increasing extent, which are charged e.g. in braking phases, and in acceleration phases Supply the hydraulic energy stored in the same to the drive system. Thus, the drive unit itself can be dimensioned Smaller, as it is supported by the high-pressure accumulator during load peaks. In known hydraulic drive systems with such high-pressure accumulator, no satisfactory efficiencies can be achieved for the storage and release of energy. A need exists for an improved hydraulic accelerator to efficiently transfer energy into and out of the hydraulic drive system.

The present invention attempts to address the existing limitations in supporting a hydraulic drive system utilizing an improved hydraulic accelerator according to the principles and example embodiments disclosed herein.

### SUMMARY

In accordance with the present invention, the above and other problems are solved by providing an article of manufacture for providing for providing an improved hydraulic accelerator within a hydraulic drive system.

In one embodiment, the present invention is an article of manufacture for providing an improved hydraulic accelerator within a hydraulic drive system.

The great utility of the invention is that an article of manufacture may provide higher hydraulic pressure increases for more efficient transfer of energy into a hydraulic drive system in order to store the transferred energy for later use.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 illustrates one potential embodiment an article of manufacture for providing an improved hydraulic accelerator within a hydraulic drive system according to the present invention.

FIG. 2a-b illustrate an example bottom blade within an article of manufacture for providing an improved hydraulic accelerator within a hydraulic drive system according to the present invention.

FIG. 3a-b illustrate an example top blade within an article of manufacture for providing an improved hydraulic accelerator within a hydraulic drive system according to the present invention.

FIG. 4a-b illustrate an example top rod and tube bearing assembly within an article of manufacture for providing an improved hydraulic accelerator within a hydraulic drive system according to the present invention.

FIG. 5 illustrates an example interior pipe assembly within an article of manufacture for providing an improved hydraulic accelerator within a hydraulic drive system according to the present invention.

FIG. 6 illustrates an example embodiment of a planetary gear assembly used within the present invention.

### DETAILED DESCRIPTION

This application relates in general an article of manufacture for providing an improved hydraulic accelerator within a hydraulic drive system.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps, or components but do not preclude the presence or addition of one or more other features, steps, or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “50-250 micrometers should be interpreted to include not only the explicitly recited values of about 50 micrometers and 250 micrometers, but also include individual values and sub-ranges within the indicated range. Thus, included in this numerical range are individual values such as 60, 70, and 80 micrometers, and sub-ranges such as from 50-100 micrometers, from 100-200, and from 100-250 micrometers, etc. This same principle applies to ranges reciting only one numerical value and should apply regardless of the breadth of the range or the characteristics being described.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the testing measurements.

As used herein, the term “about” means that dimensions, sizes, formulations, parameters, shapes and other quantities and characteristics are not and need not be exact, but may be approximated and/or larger or smaller, as desired, reflecting tolerances, conversion factors, rounding off, measurement error and the like and other factors known to those of skill. Further, unless otherwise stated, the term “about” shall expressly include “exactly,” consistent with the discussion above regarding ranges and numerical data.

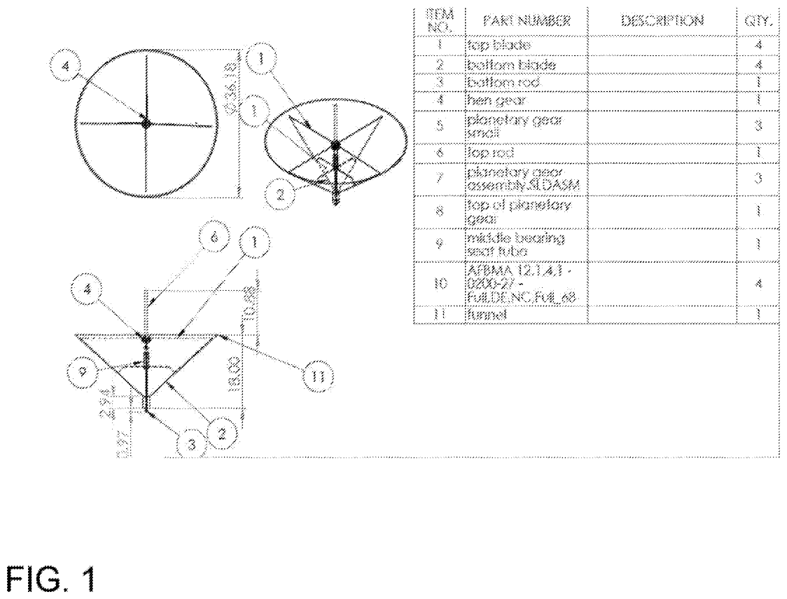

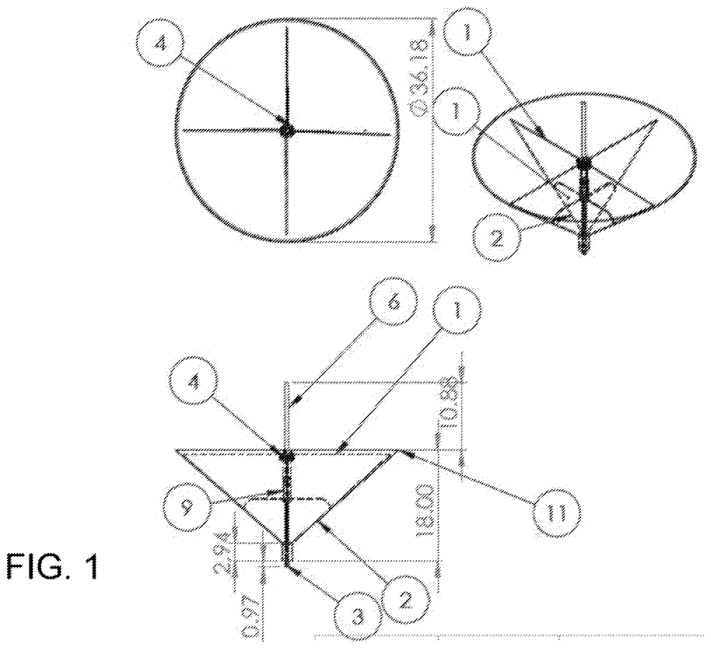

In general, the present disclosure relates general an article of manufacture for providing an improved hydraulic accelerator within a hydraulic drive system. To better understand the present invention, FIG. 1 illustrates one potential embodiment an article of manufacture for providing an improved hydraulic accelerator within a hydraulic drive system according to the present invention.

The hydraulic accelerator is constructed from a set of four (4) top blades 1, a set of four (4) bottom blades 2, a bottom rod 3, a hen gear 4, a planetary gear small 5, a top rod 6, a planetary gear assembly 7, a middle bearing seat tube 9, and a funnel 11. Each of the top blades 1 are connected to middle bearing seat tube as well as pins on an out ring gear within the planetary gear assembly 7. The set of bottom blades 2 are connected to the bottom rod 3. Both sets of blades are located at 90° angles from each other around a central axis. The central axis consists of the top rod 3 and the bottom rod 4 and the middle bearing seat tube 9.

The hen gear 4 is located near one end of the top rod 6 near the top of the middle bearing tube. The middle bearing seat tube 9 contains a set of bearings that permit the entire assembly to rotate within the funnel 11. The one end of the bottom rod 3 is coupled within the bottom two bearings of the middle bearing seat tube 9 where the opposite end of the bottom rod protrudes through the bottom of the funnel 11. One end of the top rod 6 is coupled to a top two bearing in the top end of the middle bearing seat tube 9 and the sun gear 603 within the planetary gear assembly 7. The top rod 6 and the bottom rod 3 rotate independently of each other.

The middle bearing seat tube 9 has the bottom rod spinning within the two lower bearings in the middle bearing seat tube. The top of the middle bearing seat tube 9 is coupled to the outside ring gear 601 of the planetary gear assembly and to the set of four top blades. When an input motor is applied to the bottom of the bottom rod 3, the bottom rod and set of 4 bottom blade 2 are caused to rotate. When hydraulic fluid is within the funnel 11 as the set of bottom blades 2 rotate, the hydraulic fluid moves accordingly thus inducing the set of 4 top blades 1 to rotate.

The set of 4 top blades' 2 rotation causes the middle bearing seat tube 9 and the outer ring gear 601 to rotate at the same rate. Rotation of the outer ring gear 601 is transferred to the inner sun gear 602 through the set of planetary gears 602a-c. The sun gear 603 rotates at 3× the rotation of the input motor connected to the bottom rod 3. The top rod 6 is coupled through the enter of the sun gear 603 and into the middle of the top two bearings of the middle bearing seat tube 9, and thus also rotates at a rate of 3× the rate of the input motor.

The hydraulic accelerator is filled with hydraulic fluid increasing pressure, locking drive in when the motion of the hydraulic fluid within the funnel 11 has caused the set of top blades 1 and the set of bottom blades 2 to rotate at the same rate. The rotation of the top blades 1 which is coupled to the outside ring gear 601 and the middle bearing seat tube 9 transfers the rotation through the planetary gear assembly 7, and causing a top output rod 6 to rotate at 3 times X. This increase in rotation creates energy savings on fossil fuel drive or return of energy to battery operated drive. Tripling output from single source creates significant energy output. Unit could run generator without necessity of additional energy added after start up.

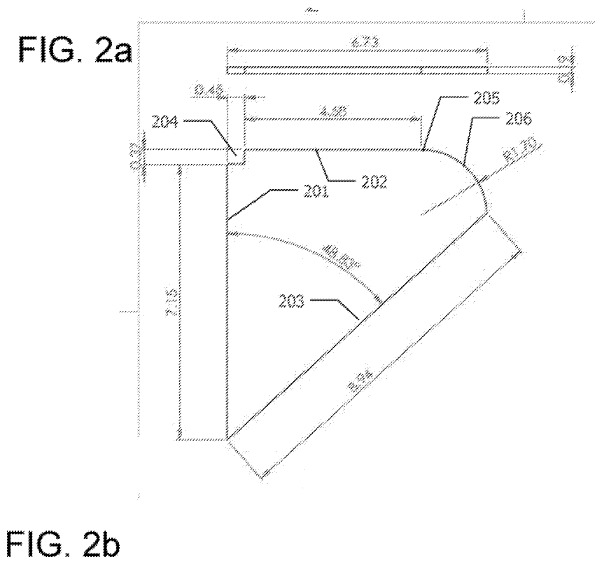

FIG. 2a-b illustrate an example a top and side view of one bottom blade within an article of manufacture for providing an improved hydraulic accelerator within a hydraulic drive system according to the present invention. FIG. 2a shows the top blade 1 to be 6.73 inches long and 0.19 inches thick. FIG. 2b shows the top blade 1 to be overall shaped like a triangle having a 0.37 by 0.45 inch notch taken 204 out of the meeting of a vertical left side 201 and a horizontal top side 202. A diagonal side 203 connects the vertical left side 201 to the horizontal top side 202.

The vertical left side 201 is 7.52 inch in length including the notch 204. The horizontal top side 202 is 6.73 inches in length along the top edge. This horizontal top side 202 includes the 0.45 in notch 204, a 4.56 inch horizontal segment 205 where the remaining length is an arc 206 made by a 1.70 inch radius circle between the horizontal top side 202 and a diagonal side 203. The diagonal side 203 connects the bottom of the vertical left side 201 with the end of the circular arc 206. The diagonal side 203 is located at a 48.83° angle from the vertical left side 201.

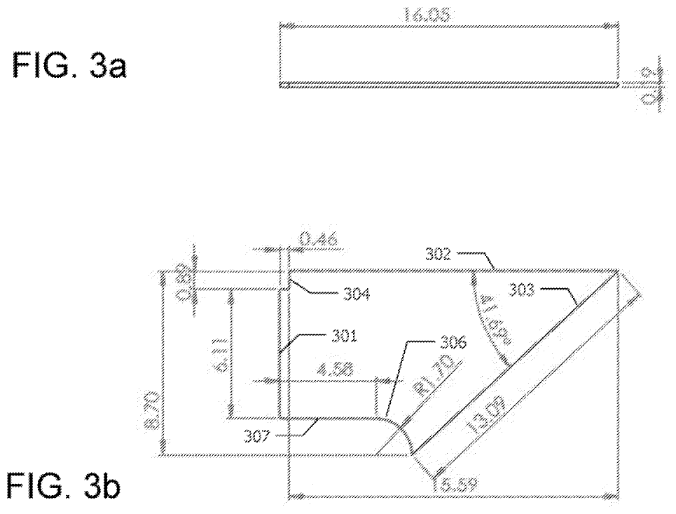

FIG. 3a-b illustrate an example bottom blade within an article of manufacture for providing an improved hydraulic accelerator within a hydraulic drive system according to the present invention. FIG. 3a shows the bottom blade 2 to be 16.05 inches long and 0.19 inches thick. FIG. 3b shows the bottom blade 2 to be overall shaped like a rectangle coupled to a left side of a triangle. An upper left corner of the rectangle has a 0.46 by 0.89 inch notch taken 304 out of the meeting of a vertical left side 301 and a horizontal top side 202. A diagonal side 303 connects the horizontal top side 302 to an arc 306 made by a 1.70 inch radius circle between a bottom left side 307 and a diagonal side 303.

The vertical left side 301 is 7.0 inch in length including the notch 304. The horizontal top side 302 is 16.05 inches in length along the top edge. This horizontal top side 202 includes the 0.46 in notch 304. The diagonal side 203 connects the right end of the horizontal top side 302 with the end of the circular arc 306. The diagonal side 303 is located at a 41.69° angle from the horizontal top side 302. The bottom left side 307 connects the opposite end of the arch 306 and the bottom of the vertical left side 301. The arc 306 of the bottom blade 2 mates with the arc 206 of the top blade when each pair of blades are joined together within the hydraulic accelerator.

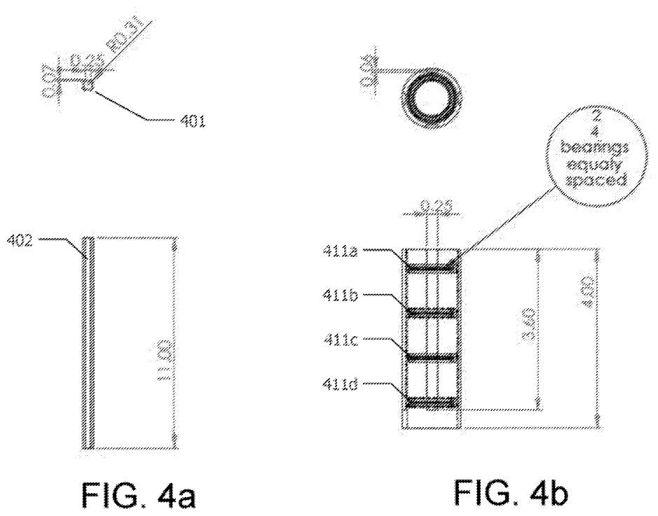

FIG. 4a-b illustrate an example top rod and middle bearing seat tube within an article of manufacture for providing an improved hydraulic accelerator within a hydraulic drive system according to the present invention. FIG. 4a shows the bottom rod 3 to be roughly a 0.39×0.39 inch square 401 in shape FIG. 4a also shows that each side of the bottom rod 3 includes a 0.07 inch channel 402 along its 11.00 inch length. Each corner of the square 401 is rounded to possess an arc of a 0.31 inch radius circle.

FIG. 4b shows a top and side view of the middle bearing seat tube that has an overall length of 4.00 inches with a thickness of 0.06 inches. The middle bearing seat tube 9 contains four (4) identical bearings 411a-d equally spaced within the middle bearing seat tube 9. The distance between the top of the middle bearing seat tube 9 and the bottom side of the lowest bearing 411d is 3.60 inches. Each bearing 411a-d has a 0.25 inch center for acceptance of the top and bottom rods.

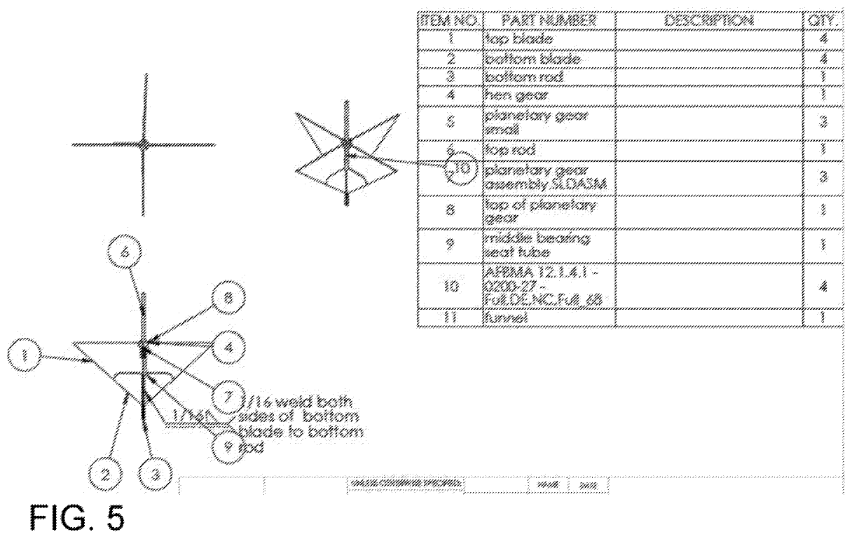

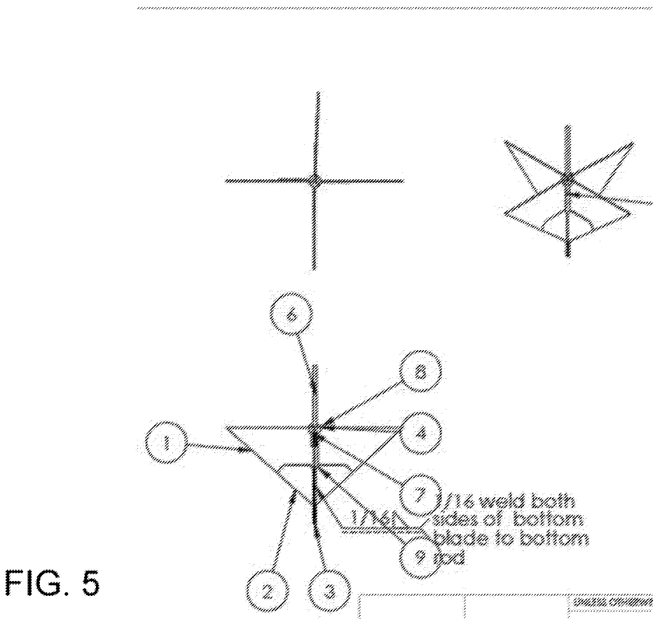

FIG. 5 illustrates an example interior assembly within an article of manufacture for providing an improved hydraulic accelerator within a hydraulic drive system according to the present invention. The interior assembly 500 includes the set of four (4) top blades 1, the set of four (4) bottom blades 2, the bottom rod 3, the hen gear 4, the planetary gear small 5, the top rod 6, the planetary gear assembly 7, and the middle bearing seat tube 9. The interior assembly 500 comprises all of the components inside the funnel 11.

The interior assembly 500 has each of the top blades 1 are located at 90° angles from each other around a central axis. The central axis consists of the top rod 3 and the bottom rod 4 that are attached to each end of the middle bearing seat tube 9.

The hen gear 4 and planetary gear assembly 7 are located adjected to each other along the top rod 6 approximately located the top of the four top blades along the central axis. The distance from the top of the top rod 6 and the hen gear 4 is 10.88 inches. The assembly rotates and transfers input motor force from the bottom rod 4 through the planetary gear assemble 7 to the output top rod 3 as discussed above.

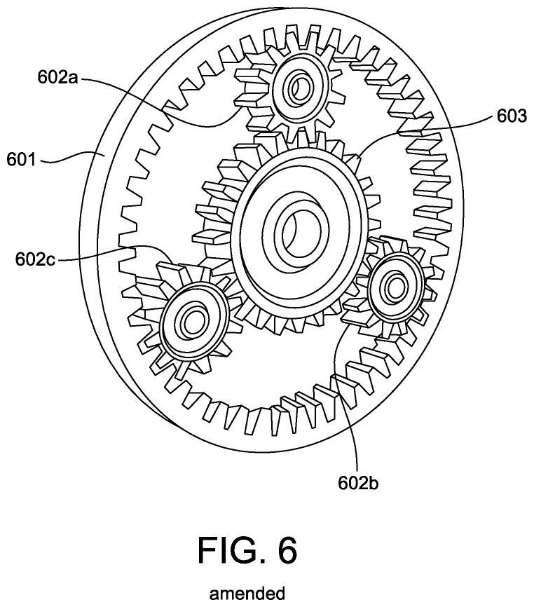

FIG. 6 illustrates an example embodiment of a planetary gear assembly used within the present invention. The planetary gear assembly 7 contains an outer gear ring 601 having teeth that engage with 3 planetary gears 602a-c. The 3 planetary gears 602a-c engage a central gear 603 and are spaced equally within the outer gear ring 601. The three components to the gear assembly function as discussed above with reference to FIG. 1.

The above figures do not show the fluid inlet or outlet or seals to prevent fluid leakage or the sleeve to separate the bearings. There are eight (8) bearings: two (2) in the top plate assemble; four (4) in the center tube attached to the top fins and ring gear assembly; and two (2) in the lower section of the funnel assembly the upper output shaft attach the sun gear of the planetary set. The smaller planetary gears have inner bearings and are attached to the top plate this will cause the output shaft to rotate faster than the input shaft causing accelerated output the unit should be started with low or zero fluid in the funnel to allow the lower fins to begin turbulence as the fluid is pumped in this would allow the upper fins to catch up to speed of the lower fins while producing a slower startup of the upper fins. Once the max fluid is in the unit it would provide a fluid lock between the lower and upper fins giving accelerated output.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

What is claimed is:

1. A hydraulic accelerator within a hydraulic drive system, the hydraulic accelerator comprises:
a funnel having a lower narrow end and a wide top end;
a bottom rod having a top end coupled within a first set of one or more bearings within a middle bearing seat tube and a bottom end protruding from the lower narrow end of the funnel, the bottom rod being an input drive shaft having induced rotation from an external source;
a plurality of bottom blades coupled along the bottom rod within the funnel, the plurality of bottom blade are equally spaces about the circumference of the bottom rod;
the middle bearing seat tube having the first set of one or more bearings and a second set of one or more bearings equally spaced along a length of the middle bearing seat tube;
a top rod having a lower end within the second set of one or more bearings within a middle bearing seat tube and an upper end coupled to a center sun gear within a planetary gear assembly;
a plurality of top blades having a top side and an inner side, the inner side coupled along the middle bearing seat tube within the funnel, the plurality of top blade are equally spaces about the circumference of the middle bearing seat tube, the plurality of top blades also being coupled along their top sides to a bottom side of a ring gear;
the planetary gear assembly comprising:
the ring gear having a top side and the bottom side;
the center sun gear within the ring gear; and
a plurality of planetary gears coupled within the planetary gear assembly between the ring gear and the sun gear, the plurality of planetary having gear teeth that engage corresponding gear teeth of the ring gear and the sun gear; and
a top lid enclosing the top of the funnel, the top lid having the top rod protruding through the top lid;
wherein the top lid is coupled to the planetary gear assembly such that rotation of the top blades induces rotation in the middle bearing seat tube and the ring gear coupled thereto; and
rotation of the ring gear causes the plurality of planetary gears, and sun gear to rotate, causing the top rod to rotate as an output drive shaft.

2. The hydraulic accelerator according to claim 1, wherein the funnel is filled with hydraulic fluid before the input drive shaft is engaged.

3. The hydraulic accelerator according to claim 1, the hydraulic accelerator further comprises a set of lower seals located about the input drive shaft and a set of upper seals located about the output drive shaft.

4. The hydraulic accelerator according to claim 1, planetary gear assembly is configured to cause the sun gear to rotate three (3) times faster than the ring gear.

5. The hydraulic accelerator according to claim 1, wherein the plurality of bottom blades comprises 4 blades located at 90 degree angles about the bottom rod; and the plurality of top blades comprises 4 blades located at 90 degree angles about the middle bearing seat tube.
